(19) United States
(12) Patent Application Publication
(10) Pub. No.: US 2011/0293947 A1
(43) Pub. Date: Dec. 1, 2011

(54) Coating Method and Structure Thereof

(75) Inventors: Chuan-Li Cheng, Taipei City (TW); Li-Wei Lin, Taipei City (TW)

(73) Assignee: Chenming Mold Ind. Corp., Taipei City (TW)

(21) Appl. No.: 12/843,597

(22) Filed: Jul. 26, 2010

(30) Foreign Application Priority Data
May 26, 2010 (TW) 099116920

(51) Int. Cl. B32B 15/08; B32B 9/04; B32B 15/098; B05D 1/36

(52) U.S. Cl. 428/422.8; 427/404; 428/447; 428/425.8

(57) ABSTRACT

The present invention discloses a coating method and a structure thereof applicable to absorb the heat radiation and heat dissipation. The method comprises the steps of: providing a metal material and an insulating material; melting the metal material and the insulating material; atomizing and spraying the metal material on a substrate at least a predetermined thickness; disposing the insulating material on the metal material.

### FIELD

The exemplary embodiment(s) of the present invention relates to a field of coating method and a structure thereof. More specifically, the exemplary embodiment(s) of the present invention relates to a field of coating method and a structure thereof applied for uniformly heating a plastic casing and dissipating the heat from the plastic casing.

### BACKGROUND

The conventional electronic devices of portable electronic apparatus such as mobile phone, notebook or personal digital assistant generate high heat during the operating time. The prior arts dissipate the heat generated by the electronic devices by a metal due to its higher heat conducting property than a plastic. In a totally sealed up plastic casing, the velocity of dissipating heat generated by the hot electronic devices out of the casing is determined by the air convection in the casing. However, in some applications, due to the limits of the design, there is not enough air inside the casing for cooling the electronic devices, so the operating temperature of the electronic devices is too high to work steadily without a crash.

Besides, the metallic casing has some disadvantages such as too heavy and hard to produce. The solution to the aforesaid problems is forming a metallic layer on the surface of a plastic casing by sputtering deposition or evaporating deposition. However, due to the concerns of manufacturing time and cost, the thickness of this kind of metal layer deposited by spurting or evaporating is not easy thicker than 1 micrometer, and the surface roughness average is very low so the surface is minor-like visually. In addition, a vacuum environment is needed for the sputtering deposition or the evaporating deposition, and it means that a vacuum chamber and a vacuum pump are needed. Nevertheless, the prices of the vacuum chamber and the vacuum pump are too expansive, and it needs a lot of time for the vacuum pump to pump out the air in the vacuum chamber to form the vacuum environment. Thus, forming a metallic layer by sputtering deposition or evaporating deposition has disadvantages such as the cost is too high and the manufacturing time is too long.

### SUMMARY

To solve the problems in the conventional arts, it is a primary object of the present invention to provide a coating method and a structure thereof to solve the problem that the conventional plastic casing could not uniformly absorb and transfer the heat, and generates a device hot concentration point.

To achieve the above object, a coating method according to the present invention is disclosed, which comprises the following steps of: providing a metal material and an insulating material; melting the metal material and the insulating material; atomizing and spraying the metal material on a substrate at least a predetermined thickness; disposing the insulating material on the metal material.

Wherein the predetermined thickness is 3˜20 micrometers.

Wherein the metal material comprises aluminum, copper, tin, or an alloy of at least two aforesaid materials.

Wherein the insulating material is an insulating paper.

Wherein the insulating material is a polymer.

Wherein the polymer comprises epoxy resin, bakelite, cyanoacrylate, methyl polyethylene, polyethylene butyl acrylate or silicone resin.

To achieve another object, a coating structure according to the present invention is disclosed, which comprises a substrate, a metal material layer and an insulating material layer. The metal material layer is disposed on the substrate and having a predetermined thickness. The insulating material layer is disposed on the metal material layer.

Wherein the predetermined thickness is 3˜20 micrometers.

Wherein the metal material comprises aluminum, copper, tin, or an alloy of at least two aforesaid materials.

Wherein the insulating material is an insulating paper.

Wherein the insulating material is a polymer.

Wherein the polymer comprises epoxy resin, bakelite, cyanoacrylate, methyl polyethylene, polyethylene butyl acrylate or silicone resin.

With the above arrangements, the coating method and structure thereof according to the present invention has the following advantage:

By disposing a metal material layer and an insulating material layer on a substrate (plastic casing), the coating method and structure thereof adsorbs the heat radiation of the hot devices inside the plastic casing. Thus, the heat is conducted diffusely by the metal material layer and out of the plastic casing. The dissipating area of the plastic casing is increased, so the hot spots of the devices are decreased.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a flow chart of a coating method in accordance with the present invention;

FIG. 2 illustrates a schematic diagram of disposing a metal material in accordance with the present invention;

FIG. 3 illustrates a schematic diagram of disposing an insulating material in accordance with the present invention; and

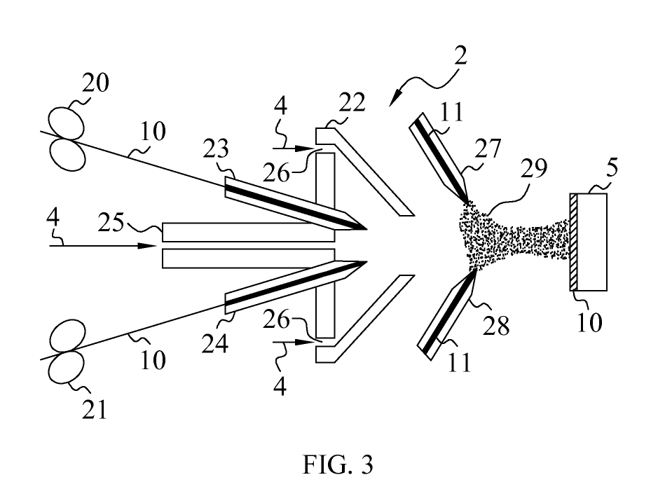

FIG. 4 illustrates a schematic diagram of a coating structure in accordance with the present invention.

### DETAILED DESCRIPTION

Exemplary embodiments of the present invention are described herein in the context of a coating method and a structure thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

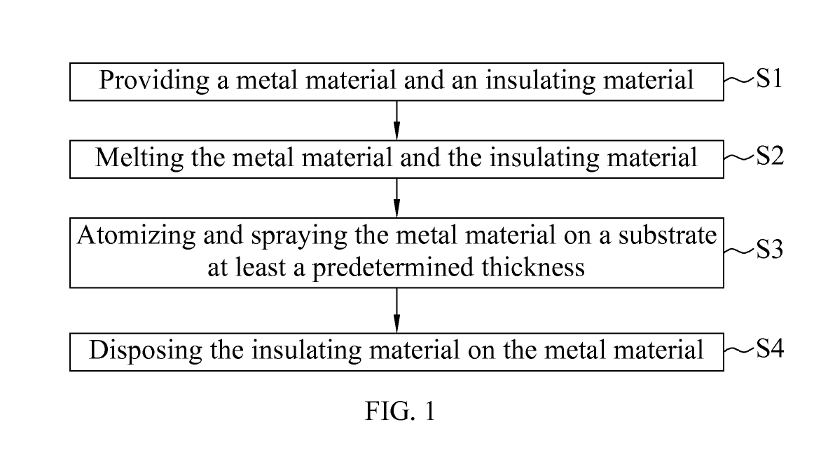

Please refer to FIG. 1, which illustrates a flow chart of a coating method in accordance with the present invention. As shown in this figure, the coating method according to the present invention comprises the following steps of: (S1) providing a metal material and an insulating material; (S2) melting the metal material and the insulating material; (S3) atomizing and spraying the metal material on a substrate at least a predetermined thickness; (S4) disposing the insulating material on the metal material.

In some preferred embodiments, the predetermined thickness could be 3˜20 micrometers; the metal material comprises aluminum, copper, tin, or an alloy of at least two aforesaid materials; the insulating material could be an insulating paper or a polymer; and the polymer comprises epoxy resin, bakelite, cyanoacrylate, methyl polyethylene, polyethylene butyl acrylate or silicone resin.

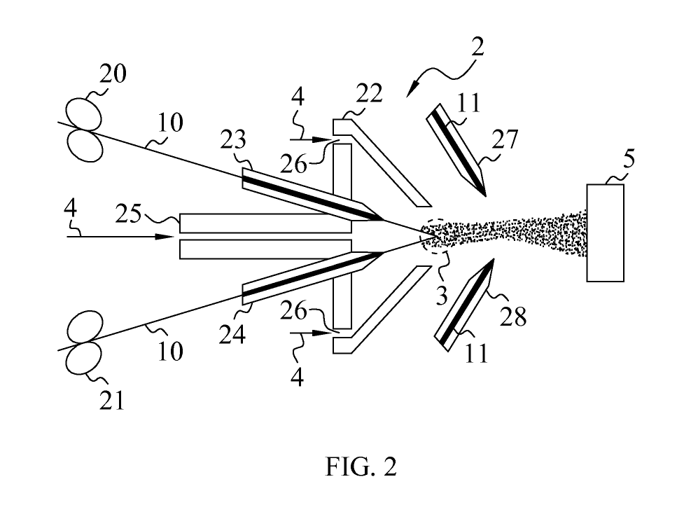

Please refer to FIG. 2, which illustrates a schematic diagram of disposing a metal material in accordance with the present invention. As shown in this figure, metal materials 10 are fed into a housing 22 of a coating system 2 by rollers 20 and 21. The metal materials 10 are given a positive electric voltage or a negative electric voltage relatively by contact pipes 23 and 24 before entering the housing 22. The metal materials 10 then generate an arc discharge at a front position 3 of the housing 22, so the metal materials 10 are melted via this arc discharge. At this time, a compressed air 4 is injected into the housing 22 through a main pipeline 25 and vice pipelines 26 so as to atomize the melted metal materials 10. Due to the directive energy of the compressed air 4 injected from the main pipeline 25, the melted metal materials 10 are sprayed onto a substrate 5 along the injected direction of the compressed air 4 form the main pipeline 25.

Please refer to FIG. 2, which illustrates a schematic diagram of disposing an insulating material in accordance with the present invention. As shown in this figure, insulating materials 11 are sprayed toward a merging region 29 through spray guns 27 and 28 disposed outside the housing 22. The merging region 29 is a region that the insulating materials 11 sprayed by the spray guns 27 and 28 are merged here. Meanwhile, the insulating materials 11 sprayed by the spray guns 27 and 28 move toward the substrate 5, and adhere the metal material 10 disposed on the substrate 5. In some preferred embodiments, the distance between the merging region 29 and the housing 22 could be 3˜15 cm, and the distance between the merging region 29 and the substrate 5 could be 20˜50 cm. In addition, in still other embodiments, disposing the insulating material layer 11 on the metal material layer 10 further comprises spin coating or adhering method.

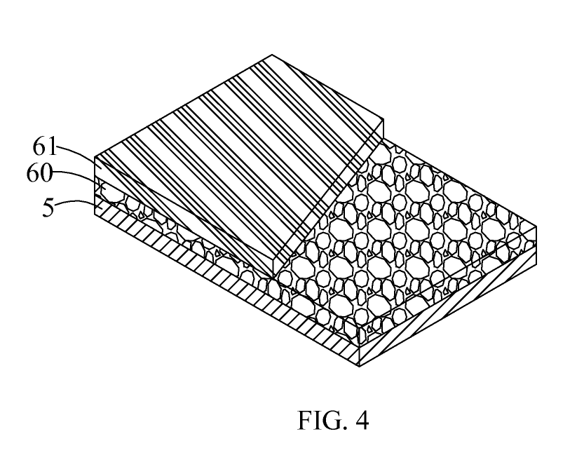

Please refer to FIG. 4, which illustrates a schematic diagram of a coating structure in accordance with the present invention. As shown in this figure, a coating structure according to the present invention comprises a substrate 5, a metal material layer 60 and an insulating material layer 61. The metal material layer 60 is disposed on the substrate 5 and having a predetermined thickness. The insulating material layer 61 is disposed on the metal material layer 60 (In order to show the metal material layer 60 under the insulating material layer 61, only part of the insulating material layer 61 is shown). The process that disposes the insulating material layer 61 on the metal material layer 60 is afore-described, and it will not be explained here again. However in this embodiment, after being atomized, the metal material of the metal material layer 60 is solidified before arriving the substrate 5, and thus the metal material is granular in the metal material layer 60. In addition, the particle-like metal materials may get together, so the diameter of the particles will not be the same. Besides, the thickness of the metal material layer 60 disposed on the substrate 5 is better 3˜20 micrometers or at least 10 micrometers. Else, the insulating material layer 61 is not connected with the electronic devices which is easy to generate high heat, the insulating material layer 61 only conduct out the heat radiation generated by the electronic devices, and the heat is further conducted by the metal material layer 60 adhered on the casing. The aforesaid metal material layer 60 comprises aluminum, copper, tin, or an alloy of at least two aforesaid materials, and the insulating material layer 61 comprises insulating paper or a polymer, such as epoxy resin, bakelite, cyanoacrylate, methyl polyethylene, polyethylene butyl acrylate or silicone resin.

By disposing a metal material layer and an insulating material layer on a substrate (plastic casing), the coating method and structure thereof according to the present invention adsorbs the heat radiation of the hot devices inside the plastic casing. Thus, the heat is conducted diffusely by the metal material layer and out of the plastic casing. The dissipating area of the plastic casing is increased, so the hot spots of the devices are decreased.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A coating method, comprising the following steps of:
providing a metal material and an insulating material;
melting the metal material and the insulating material;
atomizing and spraying the metal material on a substrate at least a predetermined thickness; and
disposing the insulating material on the metal material.

2. The coating method of claim 1, wherein the predetermined thickness is 3˜20 micrometers.

3. The coating method of claim 2, wherein the metal material comprises aluminum, copper, tin, or an alloy of at least two aforesaid materials.

4. The coating method of claim 2, wherein the insulating material is an insulating paper.

5. The coating method of claim 2, wherein the insulating material is a polymer.

6. The coating method of claim 5, wherein the polymer comprises epoxy resin, bakelite, cyanoacrylate, methyl polyethylene, polyethylene butyl acrylate or silicone resin.

7. A coating structure, comprising:
a substrate;
a metal material layer, disposed on the substrate and having a predetermined thickness; and
an insulating material layer, disposed on the metal material layer.

8. The coating structure of claim 7, wherein the predetermined thickness is 3˜20 micrometers.

9. The coating structure of claim 8, wherein the metal material comprises aluminum, copper, tin, or an alloy of at least two aforesaid materials.

10. The coating structure of claim 8, wherein the insulating material is an insulating paper.

11. The coating structure of claim 8, wherein the insulating material is a polymer.

12. The coating structure of claim 11, wherein the polymer comprises epoxy resin, bakelite, cyanoacrylate, methyl polyethylene, polyethylene butyl acrylate or silicone resin.
